(19) United States
(12) Patent Application Publication
(10) Pub. No.: US 2008/0049707 A1
(43) Pub. Date: Feb. 28, 2008

(54) Transmission packet for wireless transmission in a high frequency band, and method and apparatus for transmission/receiving using the same

(75) Inventors: Chang-yeul Kwon, Yongin-si (KR); Seong-soo Kim, Gangdong-gu (KR); Ji-sung Oh, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/783,176

(22) Filed: Apr. 6, 2007

Related U.S. Application Data
(60) Provisional application No. 60/830,115, filed on Jul. 12, 2006.

(30) Foreign Application Priority Data
Sep. 20, 2006 (KR) 10-2006-0091362

(51) Int. Cl. H04J 1/00

(52) U.S. Cl. 370/343

(57) ABSTRACT

A wireless communication technology, and more particularly, a transmission packet for wireless transmission in a high frequency band, and a method and apparatus for transmitting and receiving using the same, are described. The structure of a transmission packet may include an MPDU composed of a plurality of transmission data units, a MAC header unit added to the MPDU, and a PHY header unit added to the MAC header unit, wherein the MAC header unit includes a MAC header generated based on the information used in a MAC layer, a first HCS field which determines if an error occurred in the MAC header or the PHY header, a MAC header extension field which exists depending on the setting of an indicator field in the MAC header, and a second HCS field which determines if an error occurred in the MAC header extension field.

### CROSS-REFERENCE TO RELATED APPLICATION

This application is based on and claims priority from U.S. Provisional Application No. 60/830,115 filed on Jul. 12, 2006 in the USPTO and Korean Patent Application No. 10-2006-0091362 filed on Sep. 20, 2006 in the Korean Intellectual Property Office, the disclosure of which is incorporated herein in its entirety by reference.

### BACKGROUND OF THE INVENTION

1. Field of the Invention

The present invention relates to a wireless communication technology, and more particularly to a transmission packet for wireless transmission in a high frequency band, and method and apparatus for transmitting and receiving using the same.

2. Description of the Related Art

Technology that effectively transmits data in a wireless network environment is required due to the increase in wireless networks and the increase in demand for multimedia data transmission. Further, the need to wirelessly transmit high-quality videos, such as digital video disk (DVD) images and high definition television (HDTV) images, between a variety of home devices is increasing.

A task group of IEEE 802.15.3c is currently developing a technology standard for transmitting mass data in a wireless home network. This standard, called mmWave (Millimeter Wave), exploits radio waves with millimeter wavelengths (that is, the radio wave having frequency of 30 GHz to 300 GHz). Conventionally, this frequency band has been used for limited purposes, such as for communication service provider, navigation, and car-crash prediction.

FIG. 1 illustrates is a comparison of the frequency band of IEEE 802.11 and millimeter wave (mmWave). The Carrier frequency of IEEE 802.11b and IEEE 802.11g is 2.4 GHz, and the bandwidth is 20 MHz. Also, the carrier frequency of IEEE 802.11a or IEEE 802.11n is 5 GHz, and the channel bandwidth is 20 MHz. In contrast, mmWave uses a carrier frequency of 60 GHz, and has a channel bandwidth of approximately 0.5-2.5 GHz. Therefore, it can be recognized that mmWave has a much higher carrier frequency and a wider channel bandwidth than that of IEEE 802.11. As such, using high frequency signals (millimeter waves) allows a very high transmission rate (Gbps transmission rate), and the technology can be embodied in a single chip including an antenna less than 1.5 mm in length. Also, an attenuation ratio in the air is so high that the interference that occurs between devices can be reduced.

Recently, research has been conducted on transmitting uncompressed audio or video data (hereinafter, referred to as “AV data”) between wireless devices by using the high bandwidth that millimeter waves offer. Lossy compression is performed on AV data in a manner that removes the portions less sensitive to human hearing and sight through a process of motion compensation, DCT conversion, quantization, and variable length coding, but uncompressed AV data contains digital values (for example, R, G, B elements) as they are.

Therefore, the bits included in compressed AV data have no differing significance, but the bits included in non-compressed AV data differ in their significance. For example, as illustrated in FIG. 2, a single pixel element is expressed by 8 bits. Among the bits, the bit expressing the highest degree (the bit in the top level) is the most significant bit (MSB), and the bit expressing the lowest degree (the bit in the lowest level) is the least significant bit (LSB). That is, each bit in 1 byte of data is different in its significance for reconstructing an image signal or a sound signal. If an error occurs in a bit with high significance, it can be detected more easily than an error that has occurred in a bit with low significance. Therefore, in contrast to the bits with lower significance, the bits with high significance need to be protected so that an error does not arise. However, in the conventional method of transmitting (IEEE 802.11), a method of correcting and re-transmitting errors is used with an identical coding rate with respect to every bit to be transmitted.

FIG. 3 illustrates a structure of a PHY protocol data unit (PPDU) within the IEEE 802.11a standard. The PPDU 30 includes a preamble, a signal field, and a data field. The preamble is a signal for synchronization of a PHY layer and channel presumption, including a plurality, of long and short training signals. The signal field includes a rate field indicating transmission rate and a length field indicating the length of the PPDU. The general signal field is coded by a single symbol. The data field includes a PSDU, a tail bit, and a pad bit, but the data to be transmitted is included in the PSDU.

However, the status of channel occasionally changes between a transmitting device which transmits uncompressed AV data and a receiving device which receives the uncompressed AV data. In order to correspond to the change of transmission conditions properly, a link is optimized by controlling the parameters, such as the data rate, size of transmission packet, and the power of transmitting and receiving device. As such, the structure of a transmission packet needs to be re-defined in order to consider the characteristics of uncompressed data transmitted and received in high-frequency wireless communication in the band of several tens of Gbps.

### SUMMARY OF THE INVENTION

The present invention addresses the aforementioned problem, and provides a structure of a transmission packet wherein a MAC header extension field is added as well as the conventional MAC header and separate field for detecting an error with respect to the added field is included which more effectively corresponds to the frequently changing transmission environment of high-frequency wireless communication.

The present invention also provides a method and apparatus for transmitting and receiving transmission packets.

This and other aspects of the present invention will become clear to those skilled in the art upon review of the following description, attached drawings and appended claims.

The structure of a transmission packet according to an embodiment of the present invention includes an MPDU composed of a plurality of transmission data units, a MAC header unit added to the MPDU, and a PHY header unit added to the MAC header unit, wherein the MAC header unit includes a MAC header generated based on the information used in a MAC layer, a first HCS field which determines if an error occurred in the MAC header or the PHY header, a MAC header extension field which exists depending on the setting of an indicator field in the MAC header, and a second HCS field which determines if an error occurred in the MAC header extension field.

A transceiver is provided according to an exemplary embodiment of the present invention, wherein the apparatus includes an MPDU composed of a plurality of transmission data units, a MAC header unit added to the MPDU, and a PHY header unit added to the MAC header unit, the apparatus including a generation module which generates the transmission packet, a channel coding and decoding module which performs unequal error protection (UEP) and decoding process for the generated transmission packet, and a transmitting and receiving module which transmits and receives transmission packets, wherein the MAC header unit of a transmission packet includes a MAC header generated based on the information used in a MAC layer, a first HCS field which determines if an error occurred in the MAC header or the PHY header, a MAC header extension field which may exist depending on the setting of an indicator field in the MAC header, and a second HCS field which determines if an error occurred in the MAC header extension field.

A method of transmitting and receiving is also provided according to an exemplary embodiment of the present invention, wherein the method includes an MPDU composed of a plurality of transmission data units, a MAC header unit added to the MPDU, and a PHY header unit added to the MAC header unit, the method including generating a transmission packet, performing unequal error protection (UEP) and decoding process for the generated transmission packet, and transmitting and receiving the transmission packet, wherein the MAC header unit of the transmission packet includes a MAC header generated based on the information used in a MAC layer, a first HCS field which determines if an error occurred in the MAC header or the PHY header, a MAC header extension field which may exist depending on the setting of an indicator field in the MAC header, and a second HCS field which determines if an error occurred in the MAC header extension field.

### BRIEF DESCRIPTION OF THE DRAWINGS

The above and other aspects of the present invention will become more apparent through a detailed description of preferred embodiments thereof, with reference to the attached drawings, in which:

FIG. 1 illustrates comparing the frequency bands of IEEE 802.11 line and millimeter wave (mmWave);

FIG. 2 illustrates displaying a single pixel element as a plurality of bit levels;

FIG. 3 illustrates a structure of a PPDU of the IEEE 802.11a standard;

FIG. 4 illustrates the structure of a transmission packet according to an embodiment of the present invention;

FIG. 5 illustrates the structure of an HRP of a transmission packet in FIG. 4;

FIG. 6 illustrates the structure of a MAC header of a transmission packet in FIG. 4;

FIG. 7 illustrates the structure of MAC control field of the MAC header;

FIG. 8 illustrates the structure of a MAC header extension indicator field of the MAC header;

FIG. 9 illustrates the structure of a link adaptation (LA) component existing in MAC header extension field in the transmission packet of FIG. 4;

FIG. 10 illustrates an HRP mode index table according to an embodiment of the present invention;

FIG. 11 is a view of the configuration of a transceiver according to an embodiment of the present invention; and

FIG. 12 is a view of the configuration of a receiver according to an embodiment of the present invention.

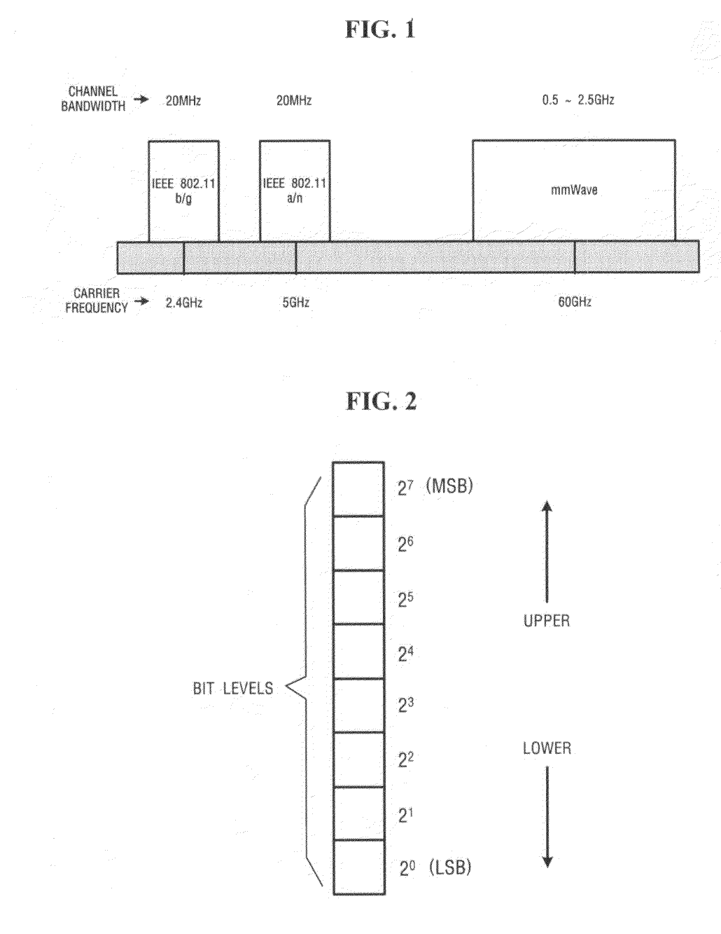

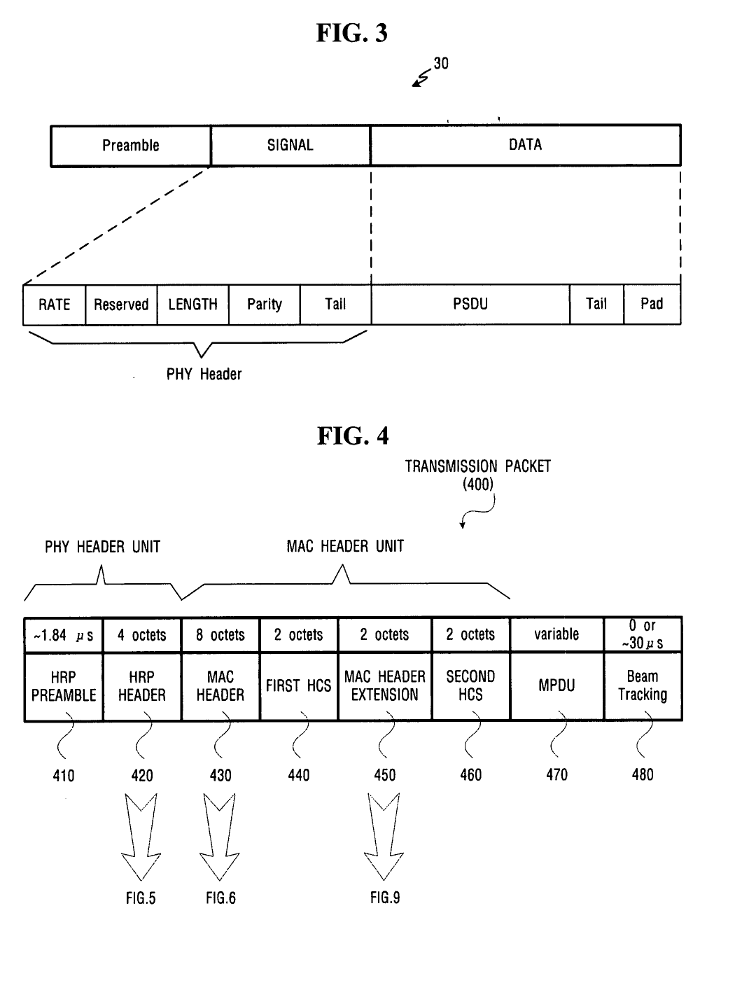

### DETAILED DESCRIPTION OF EXEMPLARY EMBODIMENTS

Exemplary embodiments of the present invention will now be described more fully with reference to the accompanying drawings.

Certain features and aspects of the present invention and methods of accomplishing the same may be understood more readily by reference to the following detailed description of exemplary embodiments and the accompanying drawings. The aspects of the present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Hereinafter, detailed description will follow with reference to a block diagram or flowcharts in order to describe a transmission packet for wireless transmission in a high frequency band, and a method and apparatus for transmitting and receiving using the same.

FIG. 4 illustrates the structure of a transmission packet 400 according to an embodiment of the present invention. The structure of the transmission packet 400 in FIG. 4 includes an HRP preamble 410, an HRP header 420, a MAC header 430, a first HCS field 440, a MAC header extension field 450, a second HCS field 460, an MPDU field 470, and a beam tracking field 480. A PHY header unit is configured by combining the HRP preamble 410 and the HRP header 420, and a MAC header unit is configured by combining the MAC header 430, the first HCS field 440, the MAC header extension field 450, and the second HCS field 460.

First, the HRP preamble 410 helps a receiver, which receives the transmission packet 400, to update synchronization assumption and channel assumption in a PHY layer and execute automatic gain control. The HRP preamble includes a plurality of short and long training signals.

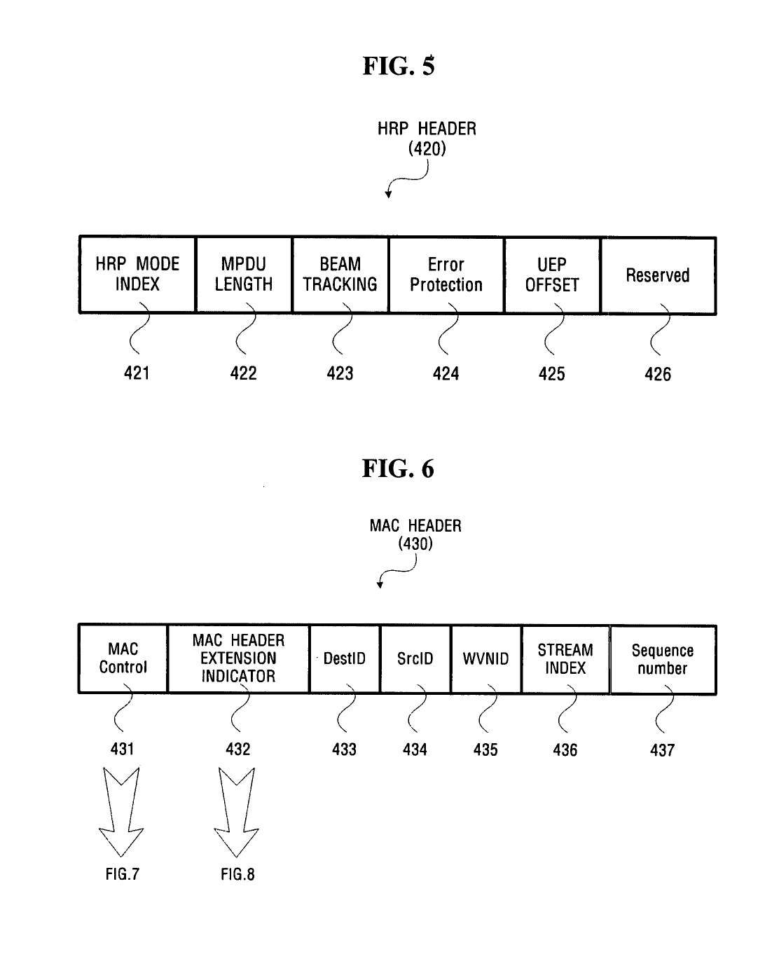

The HRP header 420 is an area generated based on the information used in the PHY layer, and transmits the transmission packet 400 using transmission rate with over several Gbps, thereby called a high rate PHY (HRP) layer. The HRP header 420 includes index information on a transmission mode of the transmission packet 400, information on the length of the MPDU 470, information displaying which of unequal error protection (UEP) and equal error protection (EEP) is applied to the data included in the MPDU 470, and information displaying the number of a symbol from which UEO coding begins, which will be described with reference to FIG. 5.

FIG. 5 illustrates the structure of an HRP header 420 of the transmission packet 400 of FIG. 4. The HRP header 420 includes an HRP mode index field 421, an MPDU length field 422, a beam tracking field 423, an error protection field 424, a UEP offset field 425, and a reserved field 426.

An index indicating combinations of information on the number of groups included in the MPDU 470, a coding rate, and a method of modulating applied to each group, is recorded in the HRP mode index field 421. According to an embodiment of the present invention, the mode index is defined to have the values 0 to 6, as the table in FIG. 10 indicating the HRP mode index table according to an embodiment of the present invention. That merely corresponds to an embodiment of the present invention, and the mode index can be defined to have the values 0 to 15 in the case of 4 bits. Fields which indicate a list, such as grouping information (the number of bit levels included in a single group), coding rate, a method of modulating, can be respectively arranged. However, using the mode index makes it possible to indicate a plurality of list combinations with one index. A transmission mode table, like FIG. 10, in which the mode index is recorded, should be pre-determined between a transmission device and a receiver, or it should be transmitted from a transmission device to a receiver.

When the HRP mode index is 0 to 2 in FIG. 10, equal error protection (EEP) is applied. When it is 3 to 4, unequal error protection (UEP) is applied. When it is 3, the QPSK is applied as a method of modulating. When it is 4, the 16-QAM is applied. In this case, a relatively lower coding rate of 4/7 is applied with respect to the first group of bit levels, and a relatively higher coding rate of 4/5 is applied with respect to the second group of bit levels. However, in this case, since the average coding rate with respect to all bit levels is 2/3, the size of the data to be transmitted is identical to the cases of HRP mode indexes 1 and 2. In the table of FIG. 10, the number of divided groups is 2 in the case where UEP is applied. However, the number of bit levels can be changed if desired. Meanwhile, in the cases of HRP mode indexes 5 and 6, a transmission error is re-transmitted due to the generation of an error. When re-transmitted, only upper bit levels with relatively higher significance are re-transmitted at 1/3 of the coding rate, and lower bit levels with relatively lower significance are not re-transmitted.

With reference to FIG. 5 again, the MPDU length field 422 displays the size of the MPDU 470 in units of octets. The MPDU length field 422 is required to precisely read out the MPDU 470 having variable size. The MPDU length field 422 may include 4 to 23 as an embodiment of the present invention. However, the size of a stuff bit used to generate the number of a symbol for the transmission packet 400 is not included in the MPDU length field 422.

When additional information for beam steering is included in the transmission packet 400, the beam tracking field 423 is set to 1. Otherwise, it is set to 0. That is, if the beam tracking field 480 in FIG. 4 is added to the MPDU 470, the beam tracking field 423 in FIG. 5 is set to 1. Otherwise, it is set to 0.

The error protection field 424 displays which of UEP and EEP is applied. It can be displayed in the error protection field 424 which mode was used among several UEP modes. If UEP is applied, the first bit of the error protection field 424 is set to 1. Otherwise, it is set to 0.

The UEP offset field 425 displays the number of the symbol from which the UEP coding begins when symbols are counted from the first symbol after the MAC header 430. As an embodiment of the present invention, the UEP offset field 425 may have the length of 27 to 36 bits. The reserved field 426 is a field prepared to be used for a specific purpose in the future.

The MAC header 430 in FIG. 4 is described with reference to FIG. 6. FIG. 6 illustrates the structure of a MAC header 430 of the transmission packet 400 of FIG. 4. The MAC header 430 includes a MAC control field 431, a MAC header extension indicator field 432, a DestID field 433, a SrcID field 434, a WVNID field 435, a stream index field 436, and a sequence number field 437.

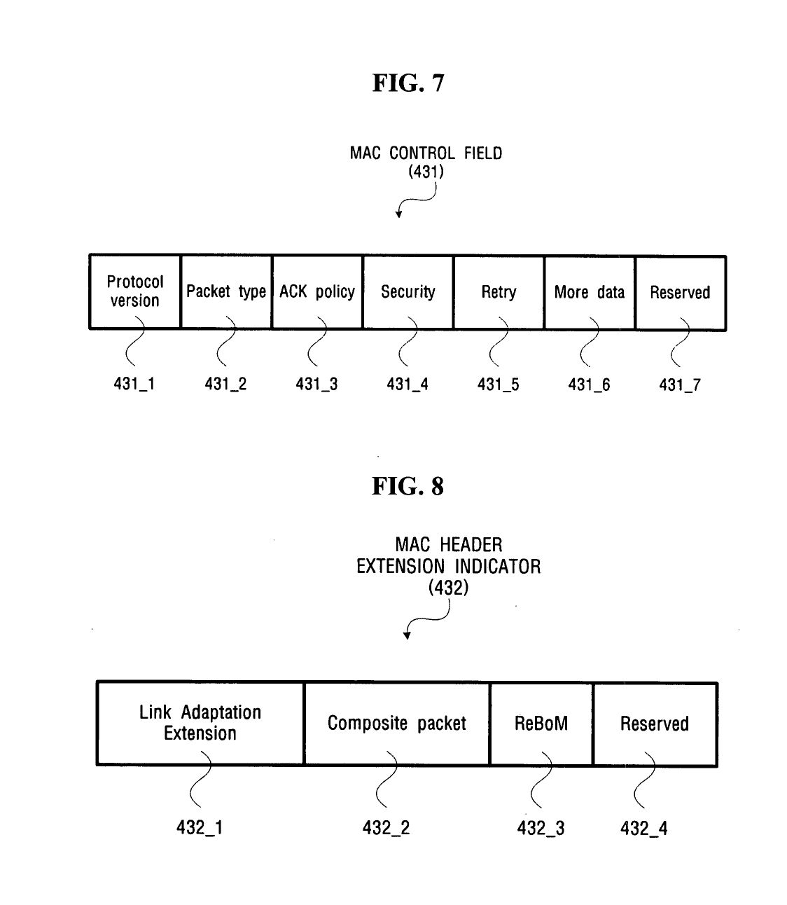

The structure of the MAC control field 431 will be described with reference to FIG. 7. A protocol version field 431_1 indicates the revision of a protocol used for transmitting and receiving the transmission packet 400. A packet type field 431_2 is a field that designates the type of packet. The type of the packet includes a beacon, MAC commands, data, a composite packet, short ACK, long ACK, reserved, and others.

An ACK policy field 431_3 indicates if the policy of an ACK frame is no-ACK, an 1 mm-ACK, or reserved.

A security field 431-4 is set to 1 when the transmission packet is a secure packet. Otherwise, it is a field with a length of 1, and is set as 0.

A retry field 431_5 is one of the packet whose transmission packet is a data packet or it is a MAC command packet. If one of the packets is transmitted, it is a 1-bit field set to 1.

A more data field 431_6 is set as 1 when a device does not transmit any more packets in the temporal block. Otherwise, it is one-bit field set to 0. A reserved field 431_7 is a field prepared to be used for a specific purpose in the future.

Referring to FIG. 6, the MAC header extension indicator field 432 is a field which indicates whether the MAC header extension field 450 in FIG. 4 exists, the description of which will follow in the part where FIG. 8 is described.

The destID field 433 is a field indicating the ID of an object device which receives the transmission packet 400, and the SrcID 434 is a field which indicates the ID of a source device which transmits the transmission packet 400.

The WVNID field 435 is a field including information on an ID of a wireless video area network in which the transmission packet is transmitted and received, and the stream index field 436 is a field including an index allotted by a coordinator for each stream of the wireless video area network.

The sequence number field 437 is a field in which a sequence number is recorded which increases with respect t6 each packet transmitted to a specific stream index.

A detailed description of the structure of the MAC header extension indicator field 432 will follow with reference to FIG. 8.

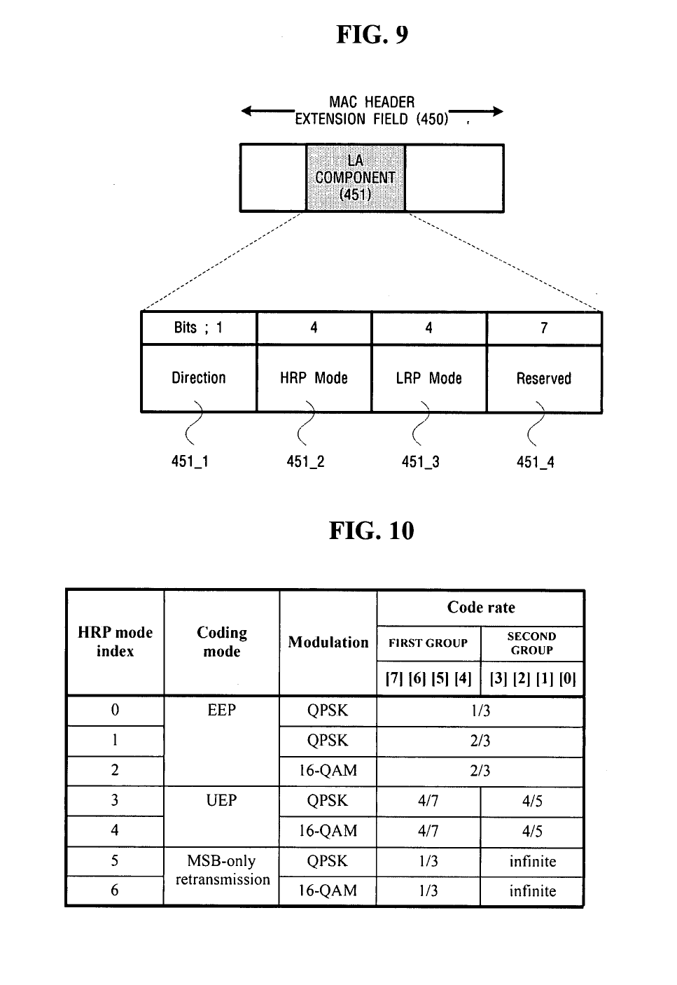

A link adaptation (LA) extension field 432_1 is a one-bit field indicating if a link adaptation component 451 included in the MAC header extension field 450 illustrated in FIG. 4 exists (description of the LA component will follow in the description of FIG. 9). That is, if a link adaptation extension 451 exists in the MAC header extension field 450 of FIG. 4, the link adaptation extension field 432_1 of FIG. 8 is set to 1.

A composite packet field 432_2 is a 1-bit indicator field. When set as 1, a composite header field (not illustrated), including 1 bit indicating how many sub-packets exist in a composite packet among the types of the mentioned packets, and n bytes indicating headers of each sub-packet, is generated in the MAC header extension field 450 illustrated in FIG. 4.

A ReBoM field 432_3 is a one-bit indicator field. When set as 1, an ACKResponse bitmap field with a length of 8 octets (not illustrated) is generated in the MAC header extension field 450 illustrated in FIG. 4. The ACKResponse bitmap field indicates that a device transmits an ACK frame to a coordinator according to a scheduling method. A reserved field 432_4 is a field prepared to be used for a specific purpose in the future.

FIG. 9 illustrates the structure of an LA component 451 in MAC header extension field 450 in the structure of transmission packet 400 in FIG. 4. It has been mentioned that the LA component 451 exists, only when the LA extension field 432_1 of FIG. 8 is set as 1.

The LA component 451 has four lower fields, that is, including a direction field 451_1 indicating information on the transmitted direction of the transmission packet 400, an HRP mode field 451_2 in which an index of a high rate PHY mode is recorded, an LRP mode field 451_3 in which an index of a low rate PHY mode is recorded, and a reserved field 451_4 to be used in the future. When length of the fields is studied, the direction field 451_1 has 1 bit, the HRP mode field 451_2 and the LRP mode field 451_3 respectively have 4 bits, and the reserved field 451_4 has 7 bits. Therefore, the LA component 451 has 16-bit length.

The direction field 451_1 may have the value of 0 or 1, since it has a 1-bit length. When it has the value of 0, a source device transmits link recommendation request data to a sync device. When it has the value of 1, the sync device transmits link recommendation response data to the source device.

A link recommendation process for transmitting and receiving the link recommendation request data and the link recommendation response data is one of the LA mechanisms. According to the link recommendation request process, the source device can obtain the information on the current channel status and the information on the setting on the HRP transmission mode recommended from an HRP mode index of a table in FIG. 10.

Meanwhile, two logical channels exist in the LA mechanism. One is a high rate PHY (HRP) channel using an OFDM modulating method in a transmission rate over 3 Gbps. The other is a low rate PHY (LRP) channel which provides an omni-directional mode having a transmission rate of 2.5 Mbps to 10 Mbps, and a beam steered mode having transmission rate of 20 Mbps to 40 Mbps.

Therefore, it can be recognized that the lower field included in the LA component 451 is divided into an HRP mode field 451_2 and an LRP mode field 451_3. Especially, recorded in the HRP mode field 451_2 is a combination of information on the coding mode, information on the modulating method, information on the number of bit levels included in a transmission data unit, and information on a transmission rate of the bit levels. It has been mentioned that one index number of the mode indexes can be selected from a table in FIG. 10. When one of the index numbers is selected from FIG. 10, the combination of information corresponding to the selected index number is changed into the recommended setting of a new transmission mode.

Back to FIG. 4, the first header check sequence (HCS) field 440 determines if an error occurred in a PHY header unit including the HRP preamble 410, the HRP header 420, and the MAC header 430. The first HCS field 440 is an international telegraph & telephone consultative committee cyclic redundancy check-16 (CCITT CRC-16), calculated through the PHY header unit and the MAC header 430. A calculation method can be used to obtain a first complement of the residual value, generated by modulo 2 division of the area where the PHY header unit and the MAC header 430 are combined, that involves using a 16^{th} degree polynomial: x¹⁶+x¹²+x⁵+1.

The second header check sequence (HCS) field 460 determines if an error occurred in the MAC header extension field 450. The second HCS field 460 is the CCITT CRC-16 calculated through the MAC header extension field 450 as the first HCS field 440 is calculated. The method of calculating the value of HCS field 460 may be identical to the method for the first HCS field 440.

A MAC protocol data unit (MPDU) 470 is an area in which data is recorded which is to be actually transmitted, that is, uncompressed AV data processed with UEP in a predetermined coding rate.

The beam tracking field 480 is an area where additional information for beam steering is recorded. Beam steering refers to setting the direction of an antenna to be suitable for the received direction of a wireless signal having direction. For example, a receiver for receiving a wireless signal having direction receives identical wireless signal having different phase from an array antenna, calculates direction of arrival (DOA) through discrete Fourier transform from the sum of the received signal, establishes the direction of the received signal through the combination of amplitude and phase, and optimizes the array antenna to the corresponding direction. To accomplish this, the information is referred to when the direction of the antenna is established in a receiver.

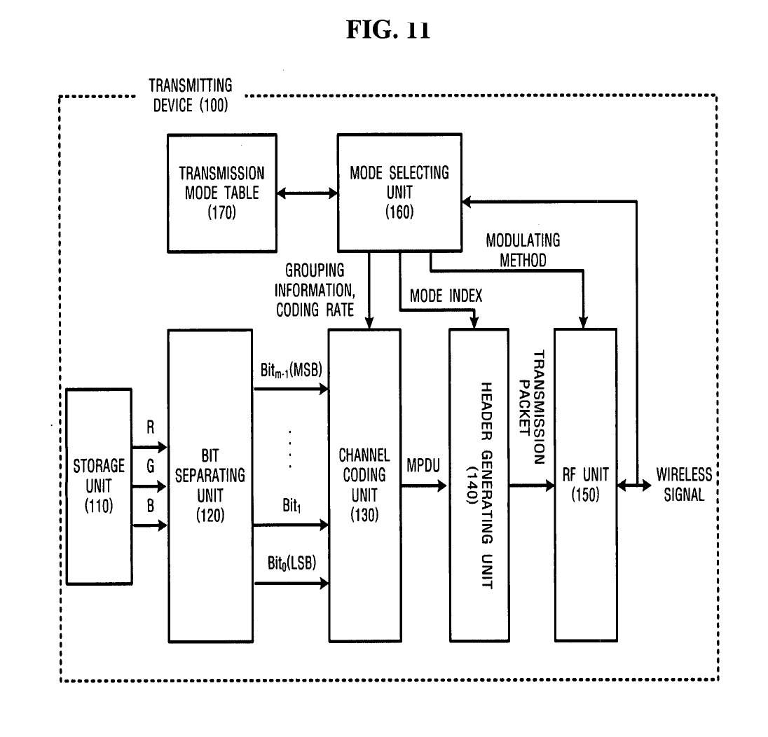

FIG. 11 is a view of the configuration of transceiver according to an embodiment of the present invention, the receiving apparatus including a storage unit 1 10, a bit separating unit 120, a channel coding unit 130, a header generating unit 140, a radio frequency (RF) unit 150, a mode selecting unit 160, and a transmission mode table 170.

Uncompressed AV data is stored in the storage unit 110. If the AV data is video data, one or more subpixel values for each pixel are stored. The subpixel values can be stored as a variety of values according to the used color area (for example, RGB color area, YCbCr color area, and the like). However, in the present invention, each pixel includes red, green, blue sub-pixels according to the RGB color area. Of course, if the image is gray, only one sub-pixel element exists, and, therefore, the one sub-pixel element becomes the whole pixel. Also, 2 or 4 sub-pixel elements can become the whole pixel.

The bit-separating unit 120 separates the value of sub-pixel provided by the storage unit 110 from high degree (high bit-level) to low degree (low bit-level). For example, in the case of 8-bit video, the degrees exist from 2⁷ to 2⁰, thereby separated into 8 bits. Here, “m” indicates the number of bits of a pixel, bitₘ₋₁ indicates the bit of m-1 degree. The bit-separating process is independently performed with respect to each sub-pixel.

The channel coding unit 130 generates a payload by performing UEP at a proper coding rate with respect to the divided bits according to the significance. The UEP is largely divided into a block coding process and a convolution coding process. The block coding process (for example, Read-Solomon coding) performs coding and decoding of data into certain block units. The convolution coding process performs coding by using a memory of a certain size and comparing the previous data and the current data.

The UEP includes process for converting the generally-inputted-k bits into a codeword of n bits. Here, the coding rate is set to “k/n”. As the coding rate reduces, the data is coded as a codeword greater than the input bit, thereby having larger possibility of UEP. When results of the UEP are collected, a payload, that is, MPDU 470 is created.

A header generating unit 140 generates the transmission packet 400 like FIG. 4 by generating and adding a PHY header unit (HRP preamble 410 and HRP header 420) and MAC header units 430, 440, 450, 460 to the MPDU field 470 including a plurality of coded TDUs. At this time, an HRP mode index is recorded in an HRP header 420. As mentioned above, the HRP mode index indicates the combination of grouping information (grouping method of TDU), coding rate, and modulating method, provided by the mode selecting unit 160.

The RF unit 150 modulates a transmission packet provided by a header generating unit 140 by using a modulating method provided by the mode selecting unit 160, and transmits it to an antenna.

The mode selecting unit 160, based on the transmission environment of the transmission packet, selects one mode index of the transmission mode table 170 like a table in FIG. 10. The mode selecting unit 160 provides grouping information and coding rate information, according to the mode index, to the channel coding unit 130, and provides a modulating method, according to the mode index, to the RF unit 150.

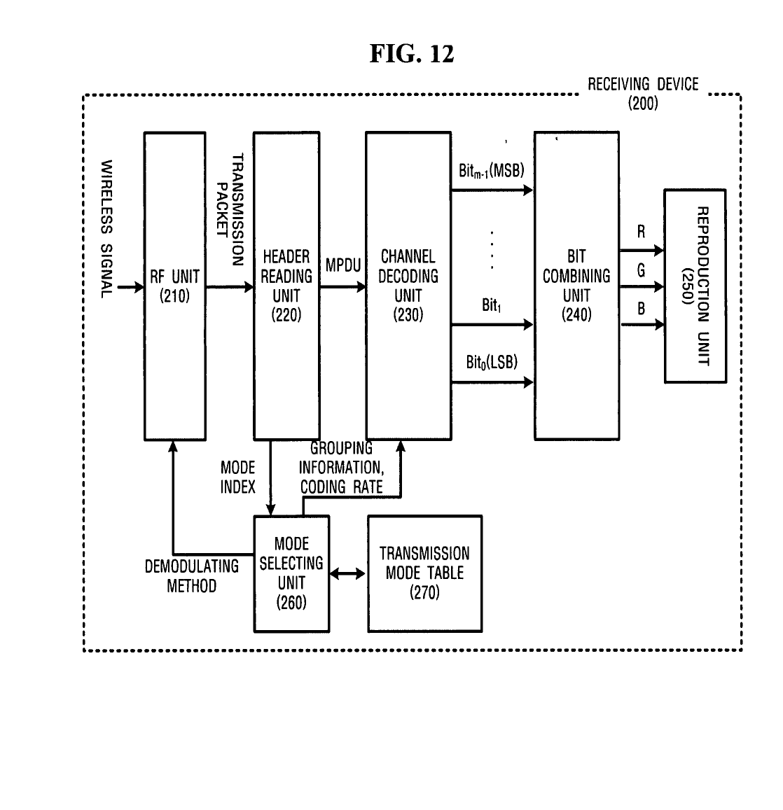

FIG. 12 is a view of the configuration of a receiver 200 according to an embodiment of the present invention. The receiver 200 includes an RF unit 210, a header reading unit 220, a channel decoding unit 230, a bit combining unit 240, a reproduction unit 250, a mode selecting unit 260, and a transmission mode table 270.

The RF unit 210 demodulates the received wireless signal and reconstructs the transmission packet. The demodulating method applied to the modulation can be provided from the mode selecting unit 260.

The header reading unit 220 reads out a PHY header and a MAC header added from the header generation unit 140 of FIG. 11, and provides an MPDU (that is, a payload) from which the headers are removed to channel decoding unit 230. Here, the header-reading unit 220 reads out a mode index recorded in the HRP header 420, and provides it to the mode selecting unit 260.

The mode selecting unit 260 selects grouping information, coding rate, and modulating method corresponding to a mode index provided from the header reading unit 220 with reference to the transmission mode table 270. The modulating method is provided to the RF unit 210, and the grouping information and coding rate are provided to the channel decoding unit 230. Then, the RF unit 210 demodulates a wireless signal according to the demodulating method.

The channel decoding unit 230 understands the types of TDU included in the current MPDU, using the grouping information provided from the mode selecting unit 260, and performs UEP decoding in a coding rate applied to the corresponding TDU. The coding rate is also provided from the mode selecting unit 260. The UEP decoding is inversely performed against the UEP coding in the channel coding unit 150, including a process of reconstructing k bits from a codeword of n bits.

The bit assembler 240 assembles bits for each bit level output (from the top level to the bottom level), and reconstructs each sub-pixel element. Each sub-pixel element (for example, R, G, B elements) reconstructed by the bit assembler 240 is provided to the reproduction unit 250.

When each sub-pixel element (that is, pixel data) is collected and one video frame is completed, the reproduction unit 250 sets the video frame in the reproduction synchronization signal and displays it via a display device, such as a cathode ray tube (CRT), a liquid crystal display (LCD), or a plasma display panel (PDP).

In the above, video data has been exemplified as uncompressed AV data. However, it will be fully understood by those of ordinary skill in the art that the identical method can be applied to a wave file and uncompressed audio data.

Hereinafter, each component, used in FIGS. 11 to 12, can be implemented by software components, such as a task, class, sub-routine, process, object, execution thread, and program, performed in a predetermined region of a memory, by hardware components, such as a Field Programmable Gate Array (FPGA) or an Application Specific Integrated Circuit (ASIC), or by combination of the software and hardware components. The components may be included in a computer-readable storage medium, or distributed in a plurality of computers with some parts dispersed.

According to an embodiment of the present invention, the present invention provides at least one of the following features.

The exemplary embodiments of the present invention have been described for illustrative purposes, and those skilled in the art will appreciate that various modifications, additions and substitutions are possible without departing from the scope and spirit of the invention as disclosed in the accompanying claims. Therefore, the scope of the present invention should be defined by the appended claims and their legal equivalents.

The features of the present invention are not limited to those mentioned above, and other aspects which have not been mentioned can be clearly understood by those of ordinary skill in the art through the following claims.

What is claimed is:

1. A computer-readable medium having physically embodied thereon a transmission packet for wireless transmission in a high frequency band, the transmission packet having a structure comprising:
a MAC protocol data unit (MPDU) composed of a plurality of transmission data units;
a MAC header unit added to the MPDU; and
a PHY header unit added to the MAC header unit, wherein the MAC header unit comprises:
a MAC header generated based on information used in a MAC layer;
a first header check sequence (HCS) field which determines if an error occurred in the MAC header or the PHY header;
a MAC header extension field which exists depending on a setting of an indicator field in the MAC header; and
a second HCS field which determines if an error occurred in the MAC header extension field.

2. The computer-readable medium of claim 1, wherein the MAC header comprises:
a MAC control field comprising information on a version of a protocol which controls the MAC header and is used for the transmission packet, information on a type of the transmission packet, and information on a policy of an ACK frame; and
a MAC header extension indicator field comprising a link adaptation extension indicator field which indicates whether a link adaptation component included in the MAC header extension field exists.

3. The computer-readable medium of claim 2, wherein the MAC header further comprises:
information on an ID of a device which transmits and receives the transmission packet;
information on an ID of a wireless video region network to which the transmission packet is transmitted and received;
information on an index of each stream in a wireless video region network; and
information on a sequence number of the transmission packet.

4. The computer-readable medium of claim 2, wherein the link adaptation component comprises:
a directional field which expresses information on a transmitted direction of the transmission packet;
a high rate PHY (HRP) mode field in which an index for information on an HRP transmission mode is recorded;
a low rate PHY (LRP) mode field in which an index for an LRP transmission mode is recorded; and
a reserved field for preliminary use in the future.

5. The computer-readable medium of claim 4, wherein the directional field is 1 bit, the HRP mode field and the LRP mode field are 4 bits respectively, and the reserved field is 7 bits.

6. The computer-readable medium of claim 5, wherein:
the directional field has a value of 0 when a mode is set as a link recommendation request mode for a transmission device transmitting the transmission packet to a receiving device, to request a link recommendation; and
the directional field has a value of 1 when a mode is set as a link recommendation response mode for the receiving device to respond to the transmitting device on the link recommendation request.

7. The computer-readable medium of claim 4, wherein a mode index indicating the combination of information on a coding mode, information on a modulating method, information on the number of bit levels included in the transmission data unit, and information on the coding rate of the bit level, is recorded in the HRP mode field.

8. The computer-readable medium of claim 1, wherein the PHY header unit comprises:
a high rate PHY (HRP) preamble which allows a receiving device which receives the transmission packet to update synchronization of a PHY layer and channel assumption, and execute automatic gain control; and
an HRP header comprising information on an index for a transmission mode of the transmission packet, information on length of the MPDU, information displaying which of unequal error protection (UEP) and equal error protection (EEP) is applied to data included in the MPDU, and information displaying the number of a symbol from which the UEP coding process begins.

9. A transceiver that transmits and receives a transmission packet, the transceiver comprising:
a generation module which generates the transmission packet, the transmission packet comprising a MAC protocol data unit (MPDU) composed of a plurality of transmission data units, a MAC header unit added to the MPDU, and a PHY header unit added to the MAC header unit;
a channel coding and decoding module which performs unequal error protection (UEP) and a decoding process for the generated transmission packet; and
a transmitting and receiving module which transmits and receives the transmission packet;
wherein the MAC header unit of the transmission packet comprises:
a MAC header generated based on the information used in a MAC layer; wherein the apparatus comprises:
a first header check sequence (HCS) field which determines if an error occurred in the MAC header or the PHY header;
a MAC header extension field which exists depending on the setting of an indicator field in the MAC header; and
a second HCS field which determines if an error occurred in the MAC header extension field.

10. The transceiver of claim 9, wherein the MAC header comprises:
a MAC control field comprising information on a version of a protocol that controls the MAC header and that is used for the transmission packet, information on the type of the transmission packet, and information on the policy of an ACK frame; and
a MAC header extension indicator field comprising a link adaptation extension indicator field which indicates if a link adaptation component included in the MAC header extension field exists.

11. The transceiver of claim 10, wherein the MAC header further comprises:
information on an ID of a device which transmits and receives the transmission packet;
information on an ID of a wireless video region network to which the transmission packet is transmitted and received;
information on an index of each stream in the wireless video region network; and
information on a sequence number of the transmission packet.

12. The transceiver of claim 10, wherein the link adaptation component comprises:
a directional field which expresses information on a transmitted direction of the transmission packet;
a high rate PHY (HRP) mode field in which an index for information on an HRP transmission mode is recorded;
a low rate PHY (LRP) mode in which an index for an LRP transmission mode is recorded; and
a reserved field for preliminary use in the future.

13. The transceiver of claim 12, wherein the directional field is 1 bit, the HRP mode field and the LRP mode field are 4 bits respectively, and the reserved field is 7 bits.

14. The transceiver of claim 13, wherein:
the directional field has a value of 0 when a mode is set as a link recommendation request mode for a transmission device transmitting the transmission packet to a receiving device, to request a link recommendation; and
the directional field has a value of 1 when a mode is set as a link recommendation response mode for the receiving device to respond to the transmitting device on the link recommendation request.

15. The transceiver of claim 12, wherein a mode index indicating the combination of information on a coding mode, information on a modulating method, information on the number of bit levels included in the transmission data unit, and information on the coding rate of the bit level, is recorded in the HRP mode field.

16. The transceiver of claim 9, wherein the PHY header unit comprises:
a high rate PHY (HRP) preamble which allows a receiving device which receives the transmission packet to update synchronization of a PHY layer and channel assumption and execute automatic gain control; and
an HRP header comprising information on an index for a transmission mode of the transmission packet, information on length of the MPDU, information displaying which of unequal error protection (UEP) and equal error protection (EEP) is applied to data included in the MPDU, and information displaying the number of a symbol from which the UEP coding process begins.

17. A method of transmitting and receiving a transmission packet over a network, the method comprising:
generating a transmission packet comprising a MAC protocol data unit (MPDU) composed of a plurality of transmission data units, a MAC header unit added to the MPDU, and a PHY header unit added to the MAC header unit;
performing unequal error protection (UEP) and decoding process for the generated transmission packet; and
transmitting and receiving the transmission packet;
wherein the MAC header unit of the transmission packet comprises:
a MAC header generated based on the information used in a MAC layer;
a first header check sequence (HCS) field which determines if an error occurred in the MAC header or the PHY header;
a MAC header extension field which exists depending on a setting of an indicator field in the MAC header; and
a second HCS field which determines if an error occurred in the MAC header extension field.

18. The method of claim 17, wherein the MAC header comprises:
a MAC control field comprising information on a version of a protocol that controls the MAC header and that is used for the transmission packet, information on the type of transmission packet, and information on the policy of an ACK frame; and
a MAC header extension indicator field comprising a link adaptation extension indicator field which indicates if a link adaptation component included in the MAC header extension field exists.

19. The method of claim 18, wherein the MAC header further comprises:
information on an ID of a device that transmits and receives the transmission packet;
information on an ID of a wireless video region network to which the transmission packet is transmitted and received;
information on an index of each stream in the wireless video region network; and
information on a sequence number of the transmission packet.

20. The method of claim 18, wherein the link adaptation component comprises:
a directional field which expresses the information on the transmitted direction of the transmission packet;
a high rate PHY (HRP) mode field in which an index for the information on an HRP transmission mode is recorded;
a low rate PHY (LRP) mode in which an index for an LRP transmission mode is recorded; and,
a reserved field for preliminary use in the future.

21. The method of claim 20, wherein the directional field is 1 bit, the HRP mode field and the LRP mode field are 4 bits respectively, and the reserved field is 7 bits.

22. The method of claim 21, wherein:
the directional field has a value of 0 when a mode is set as a link recommendation request mode for a transmission device transmitting the transmission packet to a receiving device, to request a link recommendation; and
the directional field has a value of 1 when a mode is set as a link recommendation response mode for the receiving device to respond to the transmitting device on the link recommendation request.

23. The method of claim 20, wherein a mode index indicating the combination of information on a coding mode, information on a modulating method, information on the number of bit levels included in the transmission data unit, and information on the coding rate of the bit level, is recorded in the HRP mode field.

24. The method of claim 17, wherein the PHY header unit comprises:
a high rate PHY (HRP) preamble that allows a receiving device that receives the transmission packet to update synchronization of a PHY layer and channel assumption and execute automatic gain control; and
an HRP header comprising information on an index for a transmission mode of the transmission packet, information on the length of the MPDU, information displaying which of unequal error protection (UEP) and equal error protection (EEP) is applied to data included in the MPDU, and information displaying the number of a symbol from which the UEP coding process begins.
